(19) United States
(12) Patent Application Publication
(10) Pub. No.: US 2024/0385770 A1
(43) Pub. Date: Nov. 21, 2024

(54) WRITING TO RERAM

(71) Applicant: Nordic Semiconductor ASA, Trondheim (NO)

(72) Inventor: Agnel Cletus PASANHA, Trondheim (NO)

(73) Assignee: Nordic Semiconductor ASA, Trondheim (NO)

(21) Appl. No.: 18/646,479

(22) Filed: Apr. 25, 2024

(30) Foreign Application Priority Data
May 17, 2023 (GB) 2307370.3

(51) Int. Cl. G06F 3/06

(52) U.S. Cl. CPC G06F 3/0655; G06F 3/0604; G06F 3/0673

(57) ABSTRACT

An electronic apparatus comprises a resistive random access memory (ReRAM) and hardware or software logic for reading from and writing to the ReRAM. The logic is configured, for a predetermined integer K>0 and for each word of a plurality of multi-bit words of length W bits stored at respective addresses in the ReRAM, to replace the respective word with a respective replacement value. The logic reads the word from the respective address in the ReRAM and uses a selection process to select K bits of the word. It stores the respective replacement value of length W bits at the respective address by writing to the address to flip the selected K of the bits of the word.

### CROSS REFERENCE TO RELATED APPLICATION

This application claims priority from Great Britain Application No. 2307370.3, filed May 17, 2023, which application is incorporated herein by reference in its entirety.

### TECHNICAL FIELD

This invention relates to apparatus and methods for writing to resistive random access memory (ReRAM).

### BACKGROUND

ReRAM is non-volatile memory (NVM) technology that has much lower write power requirements than flash. It can also be conveniently and compactly embedded within a system on chip (SoC) that is fabricated using a small process size.

ReRAM requires different read and write circuitry from flash. When writing to flash, it is possible to change individual one bits into zero bits, but zero bits can be changed into one bits only as part of a block-wide erase operation. By contrast, ReRAM allows bits within a word (e.g. a 128-bit word) to be flipped in either direction during a write to the address of the word. At least in some implementations, when writing a new value to an address in ReRAM, the original value already stored at the address is read first, and then write pulses are issued to flip the bits that differ between the new value and the original value. A first succession of write pulses may be issued that changes all the zero bits at the differing bit positions into one bits, followed by a second succession of write pulses that changes all the one bits at the differing bit positions into zero bits. Bits that do not differ between the original value and the new value are left unchanged. At least in some implementations, each write pulse flips a maximum of four bits, with each bit having to be located in a different respective 4-bit nibble of the same word.

When sensitive data, such as a private cryptographic key, is stored in memory (e.g. on a SoC), an attacker may try to acquire information about the data by launching a side-channel attack. Such attacks may involve measuring one or more parameters as the data is being written to the memory, such as the time take to write the data, or the electrical power consumed, and analyzing the measurements in order to gain information about the data that has been written. Even partial knowledge may compromise security, especially if the attacker can use statistical methods to combine information from multiple sources—e.g. by observing the same sensitive data being written to the memory on multiple occasions.

ReRAM is inherently vulnerable to such side-attacks due to the way in which writes are typically performed using write pulses. When original data is overwritten by new data by performing all the write pulses that flip zero bits to one bits in a first stage, and then performing all the writes pulses that change one bits to zero bits in a second stage, an attacker can obtain information about the differences between the original data and new from the amounts of time spent performing each stage. If the attacker already knows the original data, this timing information can reveal information about the new data, or if the attacker already knows the new data then it can reveal information the original data that is being overwritten.

Flipping a bit from one to zero in ReRAM typically requires more current than flipping a bit from zero to one, and thus monitoring the power consumed as an old value is overwritten by a new value can also reveal information about the data.

Embodiments of the present invention seek to improving the security of writing to ReRAM.

### SUMMARY OF THE INVENTION

From a first aspect, the invention provides an electronic apparatus comprising:
a resistive random access memory (ReRAM); and
logic for reading from and writing to the ReRAM,

wherein the logic is configured, for a predetermined integer K>0 and for each word of a plurality of multi-bit words of length W bits stored at respective addresses in the ReRAM, to replace the respective word by:
reading the word from the respective address in the ReRAM;
using a selection process to select K bits of the word; and
storing a respective replacement value of length W bits at the respective address by writing to the address to flip the selected K of the bits of the word.

From a second aspect, the invention provides a method for replacing data stored in a resistive random access memory (ReRAM), the method comprising, for a predetermined integer K>0 and for each word of a plurality of multi-bit words of length W bits stored at respective addresses in the ReRAM, replacing the respective word by:
reading the word from the respective address in the ReRAM;
using a selection process to select K bits of the word; and
storing a respective replacement value of length W bits at the respective address by writing to the address to flip the selected K of the bits of the word.

From a third aspect, the invention provides software for replacing data stored in a resistive random access memory (ReRAM), wherein the software comprises instructions which, when executed on a processor, cause the processor, for a predetermined integer K>0 and for each word of a plurality of multi-bit words of length W bits stored at respective addresses in the ReRAM, to replace the respective word by:
reading the word from the respective address in the ReRAM;
using a selection process to select K bits of the word; and
storing a respective replacement value of length W bits at the respective address by writing to the address to flip the selected K of the bits of the word.

Thus it will be seen that each word is replaced using a procedure that flips (i.e. changes one bits into zero bits, and zero bits into one bits) exactly the same number of bits for each word that is replaced. The method thus takes substantially the same time to overwrite each word, irrespective of the original word value stored at the address. It therefore provides resistance against timing attacks that seek to discover information about the original word or about the replacement word by measuring how many bits are flipped in the write procedure. Because the attacker does not know the replacement word stored at an address, it is also harder for the attacker to acquire information by monitoring a subsequent write of a new word to the same address that overwrites the replacement word.

For each word of the plurality of words, preferably only the selected K bits are flipped when storing the respective replacement value—i.e. none of the W bits of the word other than the selected K bits are flipped. (Additional bit flips may be performed if the ReRAM implements error-correcting codes (ECC), as explained in more detail below, but any such additional flips are not within the W-bit word itself.)

In some embodiments, for each word, the selection process may be such that the selected K bits all have a same respective bit value—i.e. being all zero bits or all one bits. This can provide additional protection against power analysis attacks. The K bits may, however, have a different value for some of the plurality words than for others of the plurality of words. The value of the bits that are selected for each word may depend on the distribution of bits in the word.

In some embodiments, the logic is configured, for a predetermined bit value (e.g. “0”), for each word of the plurality of words:
to determine if at least half of the bits of the word are of the predetermined bit value (e.g. “0”);
if so, to select the K bits from the bits of the word that are of the predetermined bit value (e.g. from the “0” bits); and
if not, to select the K bits from the bits of the word that are not of the predetermined bit value (e.g. from the “1” bits).

The logic may be configured to determine a count of the number of bits of the word that are of the predetermined bit value, or to determine a count of the number of bits of the word that are not of the predetermined bit value, and to use the count to determine if at least half of the bits of the word are of the predetermined bit value.

Preferably, K is no greater than the bit-length, W, of the plurality of words. It may be strictly less than W to avoid generating a replacement value of all zeros or all ones. In some embodiments, K may be no greater than 7 W/16. However, K may be at least as large as 6 W/16. In particular, in some embodiments, W=128, and 48≤K≤56.

In some embodiments, the logic may be configured to select K from an integer interval by a random process. It may be configured to select a new value of K at intervals, e.g. in response to each new instruction to erase or update a plurality of words stored in the ReRAM, or each time an entire block of the ReRAM is erased. However, the same respective value of K is used at least for replacing all the words of the aforesaid plurality of words.

Any suitable selection process may be used to select the K bits. In some embodiments, the first K bits of a same respective bit value are selected (e.g. moving along the word from the least significant bit or most significant bit until K bits of a predetermined bit value—e.g., zero—have been detected). However, in preferred embodiments the selection process is a random-selection process (e.g. a pseudo-random selection process). The replacement value may thus be a randomized value.

The random-selection process may be such that each bit of the word may be equally likely to be selected, or such that each bit of a same respective bit value may be equally likely to be selected. However, this is not essential, and bits may be selected by a non-uniform random-selection process in some embodiments. The random-selection process may be arranged to receive one or more random numbers from a random number generator and to use the received one or more random numbers to select the K bits. The electronic apparatus may comprise the random number generator, which may be a pseudo-random number generator.

It will be appreciated that the replacement value is constructed by the bit flipping logic of the electronic apparatus, and is not randomly drawn from a uniform distribution over all words of W bits. However, embodiments may provide even greater protection against side-channel attacks than randomizing ReRAM words to randomly drawn W-bit values because of the more uniform timing and/or power consumption. If an attacker were able to observe the same original value repeatedly being overwritten by a uniformly-distributed random value, a statistical analysis of the timing and/or power used across the successive writes may reveal information about the original value, such as its Hamming weight. However, by flipping the same number of bits in each write, embodiments may be able to mitigate this threat.

Each of the plurality of words may be stored at a different respective address. They may all be replaced in a single erase or write operation. However, in some embodiments or scenarios, two or more of the plurality of words may be stored at the same address at different respective times; the two or more words may be replaced (e.g. randomized by being replaced by respective randomized values) at different respective times.

The logic may be configured to replace each word of the plurality of words with a respective replacement value in response to a respective instruction to erase each of the plurality of words. The instructions may be received as individual erase instructions for each word or may be received as a single collective erase instruction for the plurality of words. The erase operation may be a standalone operation—i.e. not being accompanied by an associated data write operation. The ReRAM addresses may then be ready to have new data words written to them at a later time.

However, in some embodiments the logic is configured to replace each word of the plurality of words with a respective replacement value in response to a respective instruction to write new data to the ReRAM. The instructions may be received as individual write instructions for each word or may be received as a single collective write instruction for the plurality of words. The logic may be configured to replace each of the words before writing a respective new word to each of the plurality of words. Thus the logic may be configured, for each word of the plurality of words, after storing the respective replacement value at each respective address, to write a respective new word to each respective address.

The ReRAM may comprise a first region, and the electronic apparatus may be configured to use the logic for replacing old data words stored at addresses in the first region with respective replacement values before writing new data words to the addresses in the first region. The first region may occupy less than all the ReRAM. The ReRAM may further comprise a second region, distinct from the first region, and the electronic apparatus may be configured not to use the logic to replace old data words with respective replacement (e.g. randomized) values before writing new data to addresses in the second region. This can provide a more secure first region for storing sensitive data, while also providing a second region that is faster to write to, thereby providing flexibility in balancing security with performance.

Writing to each address to flip a selected K bits may comprise the logic initiating a succession of one or more write pulses. It may comprise the logic sending a respective data word (e.g. a 128-bit word) to a ReRAM controller of the electronic apparatus, which may be configured to generate a succession of write pulses to send to the ReRAM. Each write pulse may flip up to a maximum number of bits, e.g. up to four bits. In some embodiments, the logic is configured so that each W-bit replacement value (not including any additional ECC value) is written to the respective address by a predetermined number of write pulses that is the same for each of the plurality of words—e.g. using exactly twelve write pulses to flip exactly 48 bits for each 128-bit word.

In some embodiments, the logic may be configured to ensure the number of write pulses for flipping the selected K of the bits of the word of length W bits (and, in some embodiments, optionally also for writing an ECC value for the word) does not exceed a predetermined maximum. It may be configured to detect when the maximum would be exceeded for a word and, for that word, reduce the number of bits that are flipped to be less than K.

Any of the method steps disclosed herein may, where appropriate, be performed by software or by hardware, or by a combination of software and hardware. Software embodying the invention may be carried on a transitory signal or on a non-transitory computer-readable medium such as a magnetic or solid-state storage medium, which may form part of the electronic apparatus. In some embodiments, the software may be stored on a memory that is integrated, as an integrated circuit, with the ReRAM and a processor for executing the software.

The logic may, in some embodiments, partly or wholly comprise software logic. The electronic apparatus may comprise a processor and a memory storing software comprising instructions which, when executed by the processor, cause the processor to implement any one or more, or all, of the steps disclosed herein. The software may, in some embodiments, implement all of the logic disclosed herein. However, the software may write to an address in ReRAM by sending data (e.g. as a 128-bit word) to a hardware ReRAM controller.

In other embodiments, the logic may be partly or wholly hardware logic—i.e. comprising electronic circuitry. It may comprise digital circuitry (e.g. sequential logic) that is separate from any processor of the electronic apparatus.

In some embodiments, the logic may be provided by a combination of software instructions and hardware circuitry.

In some embodiments, the electronic apparatus (e.g. a ReRAM controller thereof) may be configured to generate respective error-correcting code (ECC) values for at least some of the words of length W bits written to the ReRAM. For at least some addresses in the ReRAM, a respective ECC value (e.g. 14 or 16 bits in length) may be stored in the ReRAM with the respective W-bit word (e.g. appended to the W-bit word), thereby storing an entry that is more than W bits in length (e.g. 128 word bits+16 ECC bits=144 bits in total). Updating the ECC values when an original W-bit word is replaced may involve flipping one or more additional “one” and/or “zero” bits, in addition to the selected K bits of the W-bit word that are flipped. This may result in additional write pulses. The ECC values may be generated by hardware circuitry that is separate from the logic that flips the selected K bits of the W-bit words.

The electronic apparatus may be an integrated circuit such as a system-on-chip (SoC). The ReRAM may be integrated with the hardware and/or software logic for reading from and writing to the ReRAM.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1 is a schematic diagram of a system-on-chip embodying the invention;

FIG. 2 is a flow chart of a method of randomizing ReRAM embodying the invention;

FIG. 3 is a plot showing the bit positions that are flipped according to two different ReRAM replacement methods, each embodying the invention;

FIG. 4 is a plot showing which bits are flipped at each write pulse when randomizing a first exemplary data word using a method embodying the invention; and

FIG. 5 is a plot showing which bits are flipped at each write pulse when randomizing a second exemplary data word using the same method as FIG. 4.

### DETAILED DESCRIPTION

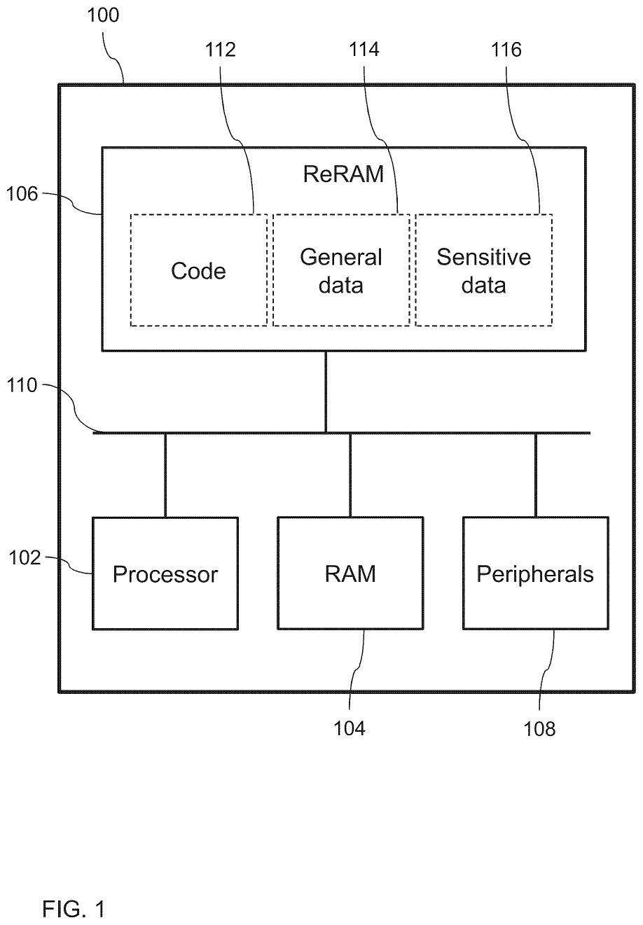

FIG. 1 schematically represents certain features of a system-on-chip (SoC) 100 embodying the invention. The SoC 100 may be embedded within a larger device, such as an appliance, a wireless IoT sensor, a vehicle, etc., which may include a power supply and off-chip components, such as an oscillator, that may be coupled to the SoC 100. The SoC 100 includes at least one processor 102, volatile random access memory (RAM) 104, non-volatile resistive random access memory (ReRAM) 106, and a number of peripherals 108, communicatively coupled to each other by a bus system 110. The peripherals 108 may include any one or more of timers, interface controllers, converters, cryptographic engines, radio transceivers, etc.

The RAM 104 may be arranged, in use, to provide short-term memory for the SoC 100, e.g. for holding variables and other data being operated on by software. The ReRAM 106 may be arranged, in use, to provide longer-term storage for software code 112 and data. It may store device firmware and/or user applications, which the processor 102 may execute directly from the ReRAM 106. It may store general data 114 that is not considered sensitive as well as sensitive data 116 that requires additional protection. Sensitive data 116 may include cryptographic private keys, confidential user data, system configuration settings, etc.

The write algorithm used by the ReRAM 106 is based on write pulses to write each ReRAM word into the ReRAM 106. In some embodiments the ReRAM 106 supports a word length of 128 bits, but this may be different in other embodiments. The write algorithm to write to a word in the ReRAM 106 performs a 4-bit write per write pulse. Each write pulse can flip at most one bit in each 4-bit nibble of the word, where the bit can be flipped either from one to zero or from zero to one. When performing a write operation, the write algorithm implemented by the ReRAM 106 control logic does not write a bit if the bit already holds the intended new value—i.e. if the bit is unchanged by the write operation. To do this, the write algorithm first reads the current data and then writes only to those bits that are changed in the new data.

In some embodiments, some or all of the ReRAM 106 may be arranged to provide error-correcting code (ECC) protection to data stored in the ReRAM 106. Each 128-bit word may be supplemented by an ECC checksum (e.g. of 16 bits in length), also stored in the ReRAM 106, appended to the 128-bit data. The checksum may be calculated when data is written to the ReRAM 106, e.g. by the ReRAM controller circuitry, and may be read and used to detect and/or correct for data corruption when reading data out of the ReRAM 106.

The SoC 100 is configured to take steps to mitigate the risk from attackers discovering sensitive data 116 stored in the ReRAM 106 by an attacker performing a side-channel attack when data is being written to the ReRAM 106. Without this protection, when sensitive data, such as a private cryptographic key, is written to a memory (e.g. on a SoC), an attacker may try to acquire information about the data by determining timing data and/or power consumption measurements while the data is being written, and analyzing these in order to gain information about the data that has been written.

The protection may be provided by novel hardware circuitry in the SoC 100, or by novel software instructions stored in the code 112 that is executed by the processor 102, or by a novel combination of hardware and software. The logic provided by the hardware or software is able to randomize data in the ReRAM 106, as part of a write operation and/or a standalone erase operation, as described in more detail below.

In order to prevent or reduce information leaking from the SoC 100 through side channels during ReRAM writes, whenever data 116 is to be written to an address in a sensitive region 116 of the ReRAM 106, the write procedure is performed in two stages: in a first stage, whatever data is currently stored at that address (i.e. the original value) is randomized. This can be seen as a form of erasing of the original value. Then, in a second stage, the new value is then written to the address. The randomization is performed in such a way that the first stage takes approximately the same amount of time and electrical power irrespective of what original value is stored at the address. This is achieved through a process referred to herein as write-pulse normalization. This can help protect the original value from being discovered by an attacker. It may also help prevent an attacker from learning the randomized value in situations where the attacker already knows the original value. Once the value at an address has been randomized, an analysis of the timing and/or power consumption of the second stage, when the new value is written to the address, is also far less likely to reveal useful information about the new value, even if the attacker knows the original value, compared with if the original value had been directly overwritten by the new value without the randomization stage.

The secure write procedure ensures that, irrespective of the original data being randomized during a ReRAM write, the number of write pulses remains the same, or nearly the same (it may vary slightly if ECC fields are appended to the words). This provides consistency of timing, to mitigate timing-based side-channel attacks.

In addition, the write procedure ensures that, when randomizing 128-bit words, either only “1” bits (i.e. bits storing one) are flipped, or only “0” bits (i.e. bits storing zero) are flipped, i.e. with no mixing of the type of bit values that are flipped (ignoring any optional appended ECC value). This provides greater consistency of power consumption compared with flipping bits in both directions, and may help mitigate power-measurement side-channel attacks.

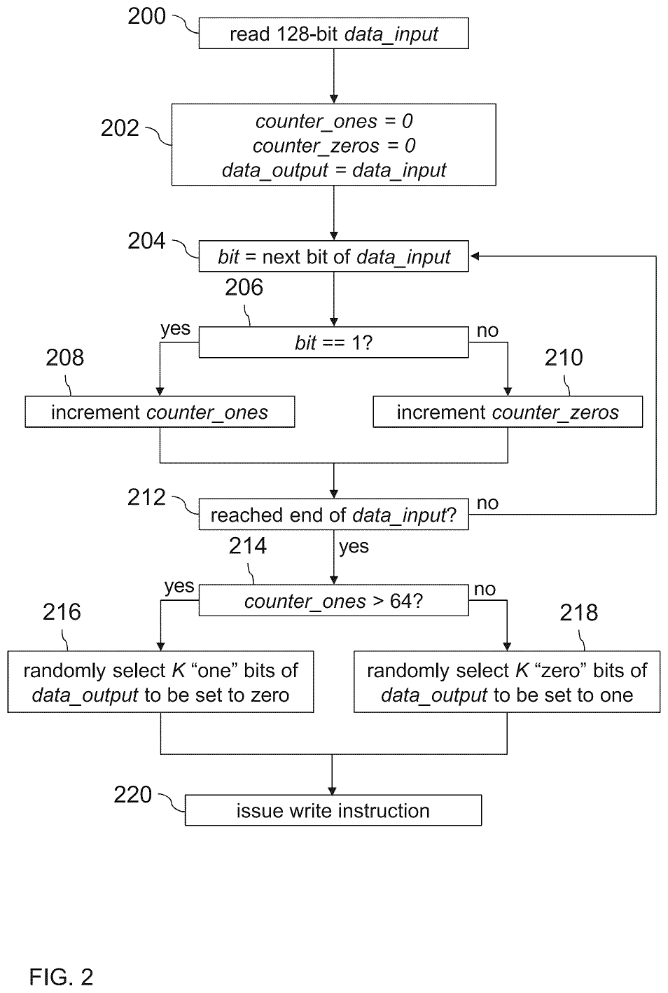

FIG. 2 shows the main steps performed by the randomizing logic for replacing an original 128-bit word stored at an address in the ReRAM 106 with a randomized 128-bit value. These steps may be performed as a standalone erase operation for one or more words, or as a prelude to writing new data to the address, after the randomized value has been written.

The SoC 100 may optionally have an ECC checksum appended to the original word, and may calculate a checksum for the randomized value, but this ECC process is separate from the randomization of the primary 128-bit word shown in the FIG. 2.

In a first step 200, the current, original 128-bit word data_input stored in the ReRAM 106 is read from the address. This may represent an older data value (e.g. part of an earlier cryptographic key), or may be an initialized state of the ReRAM 106 if no data has yet been written to the address.

Next 202, two counters (counter_ones and counter_zeros) are initialized to zero, and a variable data_output is set equal to data_input. In a software implementation, these may all be integer variables, while in a hardware implementation they may be two hardware counters and a register.

Next, the numbers of zero bits and one bits in the original word are determined by examining each bit of data_input in turn. First 204, a variable bit is set equal to the next bit of data_input, starting from the least significant bit and moving along one bit at a time to the most significant bit. Then 206, the logic checks if the current bit value is a one bit. If so, counter_ones is incremented 208. If not, counter_zeros is incremented 210.

Once the last bit has been reached 212, the loop stops and the logic determines if the value of counter_ones exceeds sixty-four—in this way, it determines if more than half the bits of the 128-bit original word are one bits. This is equivalent to determining whether or not at least half of the bits are zero bits. If more than half the bits are “1”s, the logic, in a step 216, randomly selects K of the one bits of data_output to be flipped to zeros, in a random-selection process, while not changing any other bits. Otherwise, the logic, in a step 218, randomly selects K of the zero bits of data_output to be flipped to ones, while not changing any other bits.

Although not shown in FIG. 2, the values of counter_ones and counter_zeros may, in some embodiments, be checked to see if either is zero, indicating that the data is all zeros or all ones. Where this is detected, no randomization is applied in these embodiments.

In this example implementation, if exactly 64 bits are one bits, then K zero bits are flipped. However, other embodiments may flip K one bits in this situation.

Although in preferred embodiments no bits other than the K bits of same bit value are flipped, it is possible that some embodiments could also flip one or more bits of opposite value (e.g. a fixed number of bits) of each word, and this possibility is also encompassed by the present disclosure.

The logic then sends 220 one or more write instructions to the ReRAM 106 to cause the selected K bits to be flipped.

In some embodiments, the logic may issue a write instruction that sends the whole 128-bit randomized value to a hardware ReRAM 106 controller, and this controller may then read the currently-stored (original) value and generate a succession of write pulses to flip the necessary bits of the original value. The ReRAM 106 controller may also optionally calculate and append an ECC value (without applying any randomization to the ECC portion, since the ECC value is determined entirely by the data).

The value of K may be selected as a design parameter. However, in some embodiments the SoC 100 may be arranged to select it as a random number between 48 bits and 56 bits, inclusive, and to update the value on every new erase operation performed on addresses in the sensitive data region 116. Each erase operation may erase multiple words at a time, and the same value of K is used for randomizing each of these words within the same erase operation.

The following pseudo-code represents one exemplary way in which a process for randomizing each 128-bit word might be implemented in software. An equivalent algorithm could instead be implemented in hardware. The process here flips exactly 48 bits of each word, but the parameter NUM_OF_BITS_FLIPS could instead be varied between different multi-word erase operations.

```
task randomise_word;
input [numUData-1:0] datain; // numUData = 128
output reg [numUData-1:0] dataout;
integer count_ones, count_zeros;
integer ones_index1[0:numUData-1];
integer zeros_index1[0:numUData-1];
integer ones_index[0:numUData-1];
integer zeros_index[0:numUData-1];
parameter NUM_OF_BITS_FLIPS = 48;
begin
  count_ones = 0;
  count_zeros = 0;
  for (i=0; i<numUData; i++) begin
    ones_index1[i] = 16′hFFFF;
    zeros_index1[i] = 16′hFFFF;
  end
  // find every one and zero, and record the index of each
  for (i=0; i<numUData; i++) begin
    if (datain[i] == 1)
      ones_index1[count_ones++] = i;
    else
      zeros_index1[count_ones++] = i;
  end
  // randomize the index arrays
  ones_index1.shuffle( );
  zeros_index1.shuffle( );
  // reorder shuffled arrays to take only lower NUM_OF_BITS_FLIPS
  for (i=0, j=0, k=0; i<numUData; i++) begin
    if (ones_index1[i] != 16′hFFFF)
      ones_index[j++] = ones_index[i];
    if (zeros_index1[i] != 16′hFFFF)
      zeros_index[j++] = zeros_index[i];
  end
  dataout = datain;
  if ((count_ones == numUData) || (count_ones == 0)) begin
    // already all F's or 0's so nothing to do
  end
  else if (count_ones > (numUData/2)) begin
    // more than half the bits are ones, so flip ones to zeros
    for (i=0; i<NUM_OF_BITS_FLIPS; i++) begin
      dataout[ones_index[i]] = 0;
    end
  end
  else begin
    // flip zeros to ones
    for (i=0; i<NUM_OF_BITS_FLIPS; i++) begin
      dataout[zeros_index[i]] = 1;
    end
  end
end
endtask
```

If ECC protection is being implemented, then some timing and power consumption variability may occur due to the ECC portion, but the way in which ECC values are generated limits the potential for this variability to reveal useful information to an attacker.

In one example, with K=48, and using 4-bit write pulses, randomizing a 128-bit word is expected to take 12 write pulses, but if an ECC is appended, the ECC may require between 2 and 5 write pulses depending on the randomized value that is written, such that the total write including the ECC may vary between 14 and 17 write pulses.

Some variant implementations may cap the number of write pulses required to write each word plus its ECC value, and may reduce the number of bits that are flipped for a word if the cap would be exceeded.

The write-pulse normalization may result in values that are stored in the ReRAM 106 after the first stage not being randomly drawn from a uniform distribution over all 128-bit words. Nevertheless, the applicant has recognized that the ability of an attacker to mount a successful side-channel attacker can be substantially reduced so long as some degree of unpredictability is provided, even if the resulting distribution of randomized values is not uniform. The term randomization as used herein should not therefore be understood as requiring a uniform random distribution.

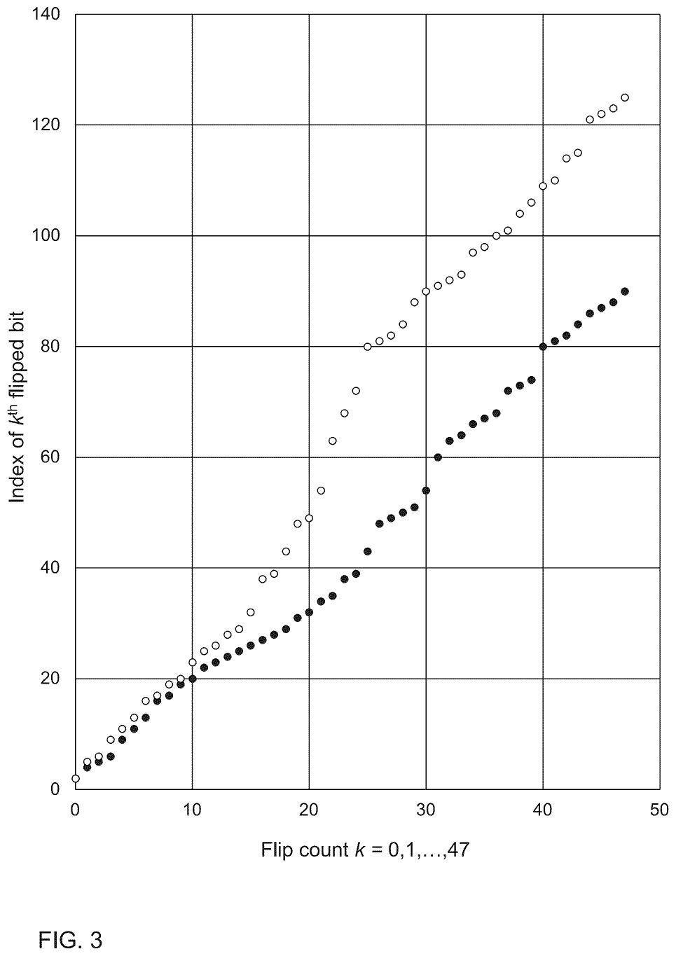

FIG. 3 compares the effect of flipping K=48 bits according to two different exemplary ReRAM data replacement methods, each embodying the invention. The forty-eight flips are spaced uniformly along the horizontal axis, while the vertical axis indicate the index within the 128-bit original word of the respective bit that is flipped by each flip. In this example, the original word is 0x368ae0e6536fdd7071d904f08cdbfdb2a74.

The method plotted with solid circles uses a replacement process that flips the first forty-eight “one” bits occurring from the least significant bit onwards, without requiring any randomness to be introduced in the selection process.

The method plotted with open circles uses a random replacement process that flips a random selection of forty-eight bits out of all the “one” bits in the original value.

The random method spreads the flips out over more of the word than the non-random replacement strategy. It may provide improved resistance to side-channel attacks, but both methods are beneficial.

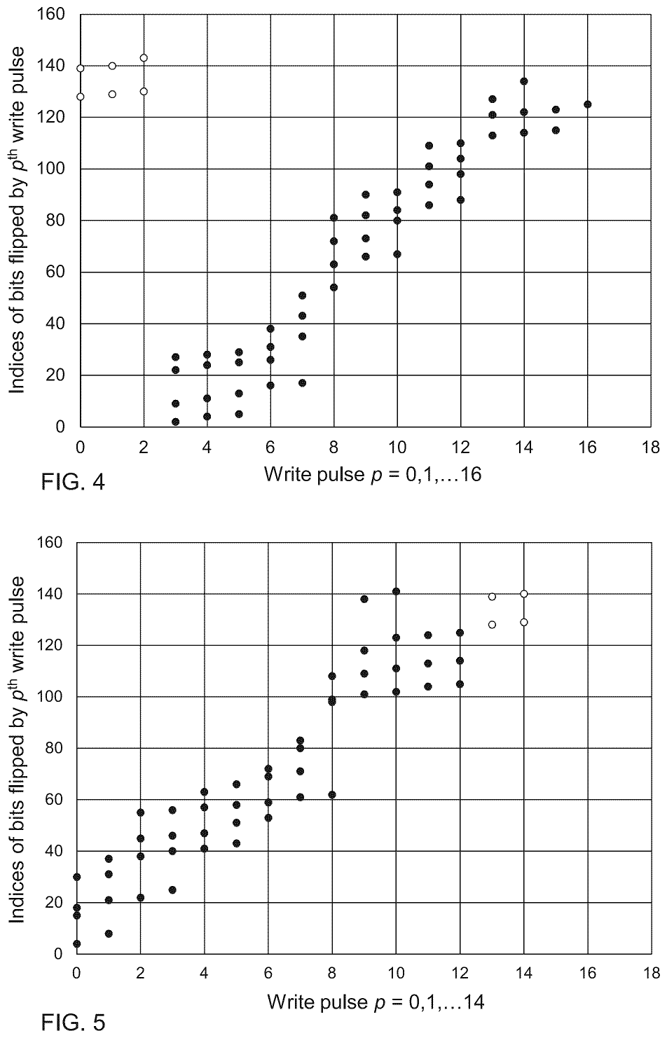

FIG. 4 is a plot showing which bits are flipped by each 4-bit write pulse when randomizing a first exemplary 128-bit data word appended with a 16-bit ECC according the methodology described with reference to FIG. 2. The original data word and appended ECC together have a value of 0x368ae0e6536fdd7071d904f08cdbfdb2a74 in this example.

The solid circles indicate the write pulses that flip zero bits to one bits. Forty-eight of these are applied to bits of the 128-bit data word, while the remaining one flip is required to write the ECC value. The open circles indicate write pulses that flip one bits to zero bits; these are only required for writing the ECC value, as no “one” bits of the data word are flipped.

FIG. 5 is another example, showing an original value for the 128-bit word with appended ECC value of 0x9b2f00000412b08004111007008500980040. Here again there are forty-eight flips of one bits to zero bits within the 128-bit word, with a further two flips of one bits for updating the ECC value to the match the new randomized replacement value. Four flips of zero bits are required for updating the ECC value.

These figures demonstrate that, even when using ECC memory, a fairly consistent number of write pulses can be used. This provides greater robustness to side-channel attacks than directly replacing old data with new data, or replacing old data with uniformly random 128-bit values.

It will be appreciated by those skilled in the art that the invention has been illustrated by describing one or more specific embodiments thereof, but is not limited to these embodiments; many variations and modifications are possible, within the scope of the accompanying claims.

We claim:

1. An electronic apparatus comprising:
a resistive random access memory (ReRAM); and
logic for reading from and writing to the ReRAM, wherein the logic is configured, for a predetermined integer K>0 and for each word of a plurality of multi-bit words of length W bits stored at respective addresses in the ReRAM, to replace the respective word by:
reading the word from the respective address in the ReRAM;
using a selection process to select K bits of the word; and
storing a respective replacement value of length W bits at the respective address by writing to the address to flip the selected K of the bits of the word.

2. The electronic apparatus of claim 1, wherein the logic is configured to flip only the selected K bits of the word when writing to the address.

3. The electronic apparatus of claim 1, wherein the selection process is such that, for each word, the selected K bits all have a same respective bit value.

4. The electronic apparatus of claim 1, wherein the logic is configured, for a predetermined bit value, for each word of the plurality of words:
to determine if at least half of the bits of the word are of the predetermined bit value;
if so, to select the K bits from the bits of the word that are of the predetermined bit value; and
if not, to select the K bits from the bits of the word that are not of the predetermined bit value.

5. The electronic apparatus of claim 4, wherein the logic is configured to determine a count of the number of bits of the word that are of the predetermined bit value, or to determine a count of the number of bits of the word that are not of the predetermined bit value, and to use the count to determine if at least half of the bits of the word are of the predetermined bit value.

6. The electronic apparatus of claim 1, wherein K is strictly less than W.

7. The electronic apparatus of claim 1, wherein the logic is configured to select K from an integer interval by a random process.

8. The electronic apparatus of claim 1, wherein the selection process selects, for each word, the first K bits of a same respective bit value.

9. The electronic apparatus of claim 1, wherein the selection process is a random-selection process that receives one or more random numbers from a random number generator and uses the received one or more random numbers to select the K bits, such that the replacement value is a randomized value.

10. The electronic apparatus of claim 1, wherein each of the plurality of words is stored at a different respective address, and wherein the logic is configured to replace all of the plurality of words in response to receiving a single collective erase instruction for the plurality of words.

11. The electronic apparatus of claim 1, wherein the electronic apparatus is configured, for a first region of the ReRAM, to use the logic for replacing old data words stored at addresses in the first region with respective replacement values before writing new data to the addresses, and, for a second region of the ReRAM, is configured not to use the logic to replace old data words stored at addresses in the second region with respective replacement values before writing new data to the addresses.

12. The electronic apparatus of claim 1, wherein the logic is configured so that each W-bit replacement value is written to the respective address by a predetermined number of write pulses that is the same for all of the plurality of words.

13. The electronic apparatus of claim 1, wherein the logic is configured such that, for each word, the number of write pulses for flipping the selected K bits, optionally including any write pulses for writing an error-correcting code value for the word, does not exceed a predetermined maximum.

14. The electronic apparatus of claim 1, wherein the logic is or comprises electronic circuitry.

15. The electronic apparatus of claim 1, wherein the logic is or comprises software logic, stored in a memory of the electronic apparatus, and comprising instructions for execution by a processor the electronic apparatus.

16. The electronic apparatus of claim 1, configured to generate respective error-correcting code values for at least some of the words of length W bits and, for each word, to store the error-correcting code value with the W-bit word in the ReRAM.

17. The electronic apparatus of claim 1, wherein the electronic apparatus is a system-on-chip.

18. A method for replacing data stored in a resistive random access memory (ReRAM), the method comprising, for a predetermined integer K>0 and for each word of a plurality of multi-bit words of length W bits stored at respective addresses in the ReRAM, replacing the respective word by:
reading the word from the respective address in the ReRAM;
using a selection process to select K bits of the word; and
storing a respective replacement value of length W bits at the respective address by writing to the address to flip the selected K of the bits of the word.

19. The method of claim 18, comprising replacing all of the plurality of words in a single erase or write operation.

20. A non-transitory computer-readable medium storing software for replacing data stored in a resistive random access memory (ReRAM), wherein the software comprises instructions which, when executed on a processor, cause the processor, for a predetermined integer K>0 and for each word of a plurality of multi-bit words of length W bits stored at respective addresses in the ReRAM, to replace the respective word by:
reading the word from the respective address in the ReRAM;
using a selection process to select K bits of the word; and
storing a respective replacement value of length W bits at the respective address by writing to the address to flip the selected K of the bits of the word.
